(19) United States
(12) Patent Application Publication
(10) Pub. No.: US 2026/0111542 A1
(43) Pub. Date: Apr. 23, 2026

(54) SYSTEM AND METHOD FOR DETECTING ADVERSARIAL EXAMPLES

(71) Applicant: University of South Florida, Tampa, FL (US)

(72) Inventors: Yasin Yilmaz, Tampa, FL (US); Furkan Mumcu, Tampa, FL (US)

(21) Appl. No.: 19/361,352

(22) Filed: Oct. 17, 2025

Related U.S. Application Data
(60) Provisional application No. 63/708,498, filed on Oct. 17, 2024.

(51) Int. Cl. G06F 21/55

(52) U.S. Cl. CPC G06F 21/554; G06F 2221/033

(57) ABSTRACT

An exemplary lightweight universal detection system and method are disclosed for detecting adversarial attacks. In one example, the proposed system and method can analyze varying degrees of impact of attacks on different layers of deep neural networks (DNNs). The system can observe internal changes to a subset of layers of an adversarial detection machine learning component due to input data and determine whether the input data is adversarial or clean based on the observed internal changes.

### CROSS-REFERENCE TO RELATED APPLICATION

This application claims priority to, and the benefit of, U.S. Provisional Patent Application No. 63/708,498, filed Oct. 17, 2024, entitled “DETECTING ADVERSARIAL EXAMPLES,” the content of which is incorporated by reference herein in its entirety.

### BACKGROUND

Deep Neural Networks (DNNs) are employed in various applications, including image classification, natural language processing, and autonomous systems. However, DNNs are vulnerable to adversarial examples, inputs intentionally perturbed in a way that is imperceptible to humans but causes the model to produce incorrect or unexpected outputs.

Various adversarial attacks have been developed to mislead the DNNs. The adversarial attacks can exploit the high-dimensional and non-linear nature of the neural networks, crafting perturbations that shift the input across decision boundaries without altering its semantic content. As a result, even well-trained models can be fooled with minimal input modifications.

Current detection systems and methods are ineffective at detecting adversarial attacks, allowing adversarial inputs to propagate through DNNs undetected. There is a need for systems and methods that can detect adversarial attacks early, before they modify or affect the operations of the DNNs.

### SUMMARY

An exemplary lightweight universal detection system and method are disclosed for detecting adversarial attacks that can analyze varying degrees of impact of attacks on different layers of DNNs, for example. In one implementation, a lightweight regression model that predicts deeper-layer features from early-layer features and uses the prediction error to detect adversarial samples is provided. The proposed system and method is highly effective, computationally efficient for real-time processing, compatible with any DNN architecture and applicable across different domains, such as image, video, and audio.

In some implementations, a system for detecting adversarial inputs to a machine learning model is provided. The system can include: at least one processor; and a memory having instructions thereon, wherein the instructions when executed by the at least one processor, cause the at least one processor to: receive, by an adversarial detection machine learning component, input data; observe, by applying layer regression operations, internal changes to a subset of layers of the adversarial detection machine learning component caused by the input data; and determining whether the input data is adversarial or clean based on the observed internal changes.

In some implementations, applying the layer regression operations includes: generating an output vector for each of a plurality of segments in a subset of layers of the adversarial detection machine learning component; generating a feature vector from the generated output vectors; predicting behavior of the machine learning model using the generated feature vector; and comparing actual behavior of the machine learning model with the predicted behavior.

In some implementations, generating the output vector for each of a plurality of segments in the subset of layers includes: applying a slicing function to the subset of layers to generate each output vector.

In some implementations, predicting behavior of the machine learning model using the generated feature vector includes: comparing a determined loss associated with the feature vector to a predetermined threshold, wherein the threshold is determined by calculating a corresponding loss for a set of clean inputs.

In some implementations, the subset of layers are selected from intermediate and/or succeeding layers of a plurality of layers of the adversarial detection machine learning component.

In some implementations, the adversarial detection machine learning component is a trained multilayer perceptron (MLP).

In some implementations, the adversarial detection machine learning component is trained by optimizing weights (w) to minimize mean squared error (MSE) loss.

In some implementations, the memory includes instructions which when executed by the at least one processor cause the at least one processor to further: generate an alert and/or take a corrective action in response to determining that the input data is adversarial.

In some implementations, the machine learning model is employed in an image recognition, video analysis, or audio recognition system.

In some implementations, the adversarial detection machine learning component is an add-on module to the machine learning model.

In some implementations, the machine learning model is a deep neural network model.

In some implementations, a computer-implemented method is provided. The method can include: receiving, by at least one processor and via an adversarial detection machine learning component, input data, wherein the adversarial detection machine learning component is a component of a machine learning model; observing, by the at least one processor and by applying layer regression operations, internal changes to a subset of layers of the adversarial detection machine learning component caused by the input data; and determining, by the at least one processor, whether the input data is adversarial or clean based on the observed internal change.

In some implementations, applying the layer regression operations includes: generating, by the at least one processor, an output vector for each of a plurality of segments in a subset of layers of the adversarial detection machine learning component; generating, by the at least one processor, a feature vector from the generated output vectors; predicting, by the at least one processor, behavior of the machine learning model using the generated feature vector; and comparing actual behavior of the machine learning model with the predicted behavior.

In some implementations, generating the output vector for each of a plurality of segments in the subset of layers includes: applying by the at least one processor, a slicing function to the subset of layers to generate each output vector.

In some implementations, predicting behavior of the machine learning model using the generated feature vector includes: comparing a determined loss associated with the feature vector to a predetermined threshold, wherein the threshold is determined by calculating a corresponding loss for a set of clean inputs.

In some implementations, the adversarial detection machine learning component is a trained multilayer perceptron (MLP).

In some implementations, the adversarial detection machine learning component is trained by optimizing weights (w) to minimize mean squared error (MSE) loss.

In some implementations, the method further includes: generating an alert and/or taking a corrective action in response to determining that the input data is adversarial.

In some implementations, the machine learning model is a DNN employed in an image recognition, video analysis, or audio recognition system.

In some implementations, a computer program product is provided. The computer program product can include at least one non-transitory computer-readable storage medium having computer-readable program code portions stored therein, the computer-readable program code portions including program code instructions, the computer program code instructions, when executed by a processor, being configured to cause the processor to: receive, by an adversarial detection machine learning component, input data; observe, by applying layer regression operations, internal changes to a subset of layers of the adversarial detection machine learning component caused by the input data; and determining whether the input data is adversarial or clean based on the observed internal changes.

### BRIEF DESCRIPTION OF DRAWINGS

FIG. 1 illustrates an example system, in accordance with certain embodiments of the present disclosure.

FIG. 2A and FIG. 2B are flowchart diagrams of example methods, in accordance with certain embodiments of the present disclosure.

FIG. 3A shows (i) an example impact of adversarial samples on the first and final layers of a deep neural network (DNN) model and (ii) an example estimation error for adversarial and clean samples.

FIG. 3B shows an example estimation error of approximations by the exemplary detection system and method.

FIG. 3C shows an example detection system and method for adversarial examples (also referred to as an adversarial examples detector).

FIG. 3D shows an example algorithmic implementation of the exemplary detection system and method in FIG. 3C.

FIG. 3E shows an example algorithm for randomly selecting layers between ⅕ and ⅘ of all layers in a DNN.

FIG. 4A shows the processing time per sample (PTS) in seconds versus AUROC for various defense methods, including an experimental detector, joint photographic experts group compression (JPEG), randomization (Random), deflection (Deflect), feature squeezing (FS), wavelet denoising (Denoise) and super resolution (WDSR), vision-language attack detection (VLAD), and expected perturbation score-based adversarial detection (EPS-AD).

FIG. 4B shows the performances of defense methods (e.g., experimental detector, EPS-AD, JPEG, Random, Deflect, VLAD, Denoise, WDSR, FS) against the ViT-PGD model-attack pair.

FIG. 4C shows some attacked and clean samples for speech recognition (by Wav2vec model) with ground truth, recognized text, word error rate (WER), and mean-squared error (MSE) values of the experimental detector.

FIG. 5 shows an example computing device.

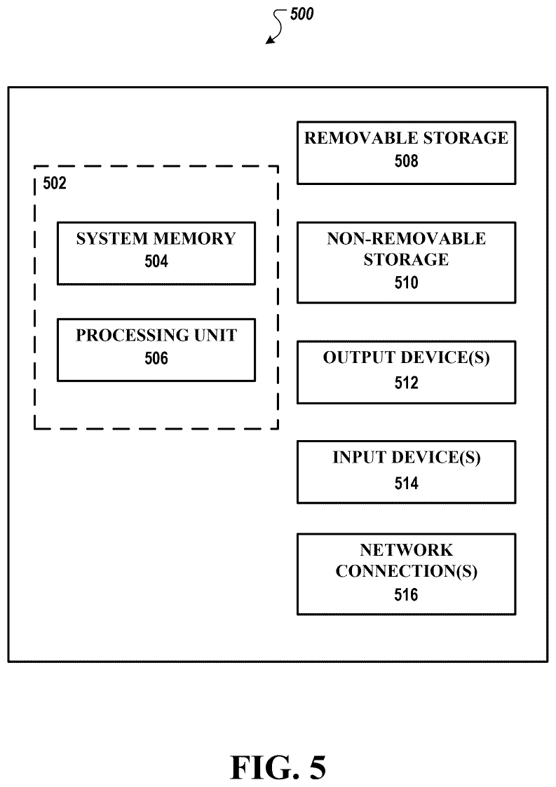

It should be appreciated that the logical operations described herein with respect to the various figures may be implemented (1) as a sequence of computer-implemented acts or program modules (i.e., software) running on a computing device (e.g., the computing device described in FIG. 5), (2) as interconnected machine logic circuits or circuit modules (i.e., hardware) within the computing device and/or (3) a combination of software and hardware of the computing device.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

The exemplary adversarial detection system and method offer various advantages and provide the first universal and efficient adversarial detection method that leverages nonuniform impacts of adversarial samples on different DNN layers. The proposed layer regression methodology significantly outperforms existing techniques and is suitable for detecting action recognition and speech recognition attacks. In addition to its high performance across a wide range of domains, models, and attacks, the proposed system and method is also very lightweight and orders of magnitude faster than existing systems, making it ideal for real-time attack detection and resource-constrained systems.

### Example System

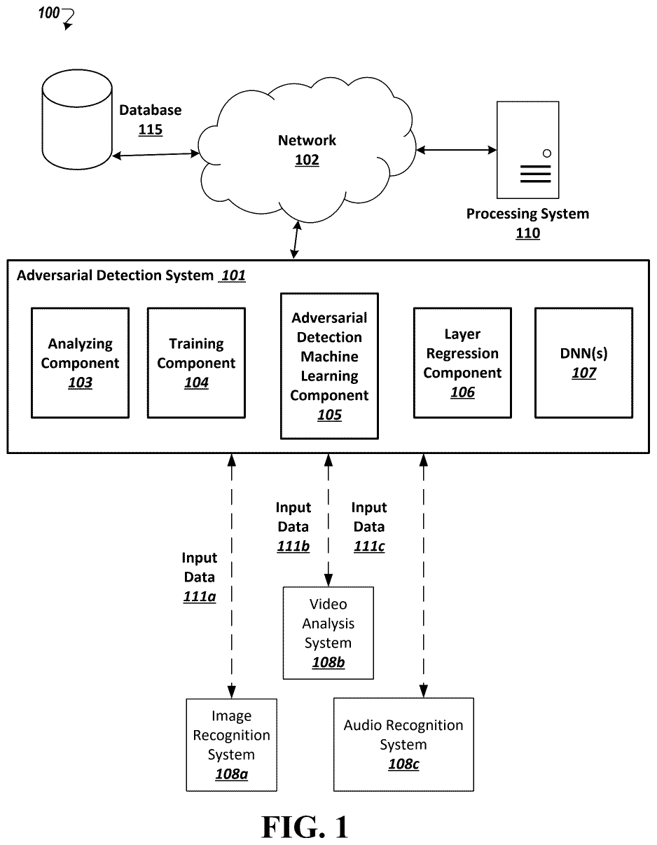

FIG. 1 is an example system 100 in accordance with certain embodiments of the present disclosure. As shown in FIG. 1, the system 100 includes a processing system 110 configured to communicate with an adversarial detection system 101. The processing system 110 can store/host data for use by the adversarial detection system 101. In various implementations, the processing system 110 and the adversarial detection system 101 are configured to transmit data to and receive data from one another over a network 102. The system 100 can include one or more databases, data stores, repositories, and the like. As shown, the system 100 includes database(s) 115 in communication with the adversarial detection system 101 and the processing system 110. In some implementations, the database(s) 115 can be hosted by the processing system 110.

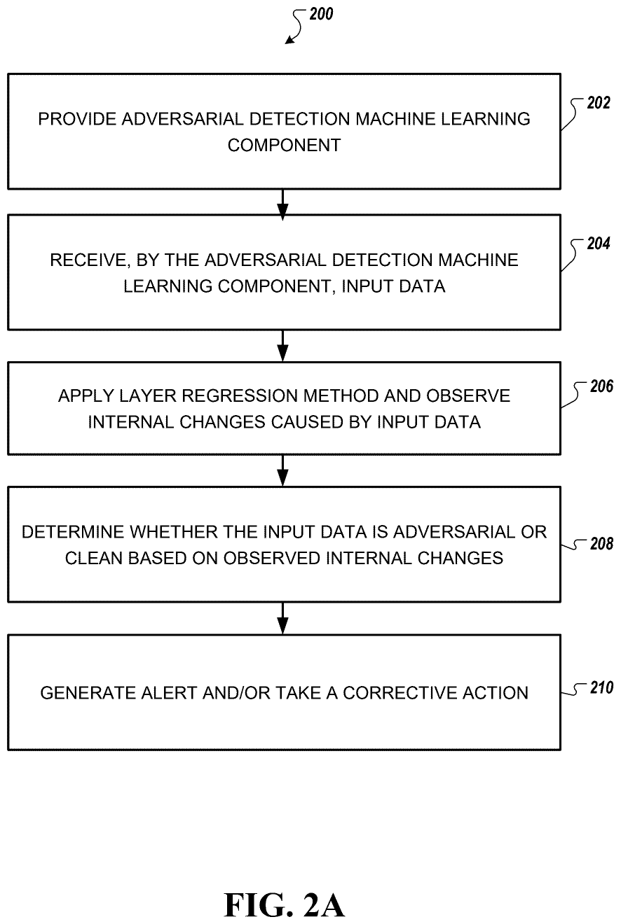

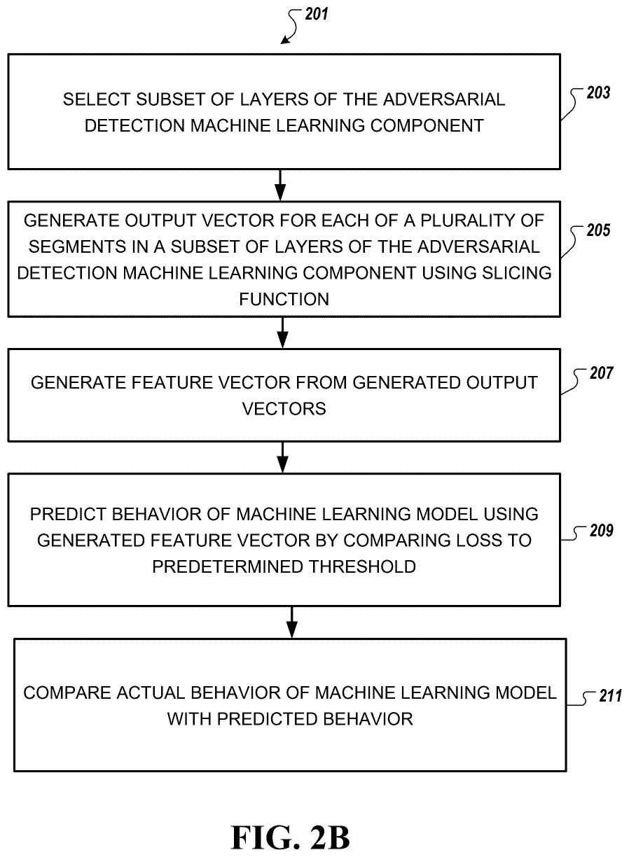

In some implementations, as illustrated, the adversarial detection system 101 includes an analyzing component 103, artificial intelligence/machine learning model training component(s) 104, adversarial detection machine learning component(s) 105 (e.g., one or more multilayer perceptrons (MLPs), layer regression component(s) 106, and DNNs 107 configured to perform the methods 200, 201 described in connection with FIG. 2A and FIG. 2B using the proposed layer regression (LR) method. In accordance with certain embodiments, one or more of the components of FIG. 1 may be implemented using cloud services to process input data 111a, 111b, 111c, perform various operations using the disclosed adversarial detection machine learning component 105/layer regression component 106 and return processed data, including predictive outputs, to other computing devices associated with different types of services. As illustrated, the adversarial detection system 101 is in electronic communication with one or more image recognition systems 108a, one or more video analysis systems 108b, one or more audio recognition systems 108c, and/or the like. For example, the components shown in FIG. 1 may be in the same or different cloud service environments and may communicate with each other over one or more network connections, such as, a LAN, WAN, Internet or other network connectivity. Input data 111a, 111b, 111c received from other services from the cloud service client can be processed, and various outputs can be determined and transmitted to the systems 108a, 108b, 108c. It should be understood that embodiments of the present disclosure using cloud services can use any number of cloud-based components or non-cloud based components to perform the processes described herein. This disclosure contemplates that the system and method can be individually implemented by the various systems 108a, 108b, 108c which can also each include some or all of the components of the adversarial detection system 101.

Referring now to FIG. 2A, a flowchart diagram depicting an example method 200 employing the proposed system and method is provided. This disclosure contemplates that the example methods 200, 201 can be at least partially performed via the system 100 described above in relation to FIG. 1 and/or performed using one or more computing devices (e.g., at least the configuration illustrated in FIG. 5 by box 502). The methods 200, 201 can be employed by one or more image recognition systems, video analysis systems, audio recognition systems, and/or the like.

At step/operation 202, the method 200 includes providing an adversarial detection machine learning component, for example, a trained MLP. In some implementations, step/operation 202 includes generating, configuring, and/or training the adversarial detection machine learning component using clean data (e.g., non-adversarial samples). The adversarial detection machine learning component can be trained by optimizing weights (w) to minimize mean squared error (MSE) loss as described in more detail below. In some embodiments, the adversarial detection machine learning component is part of or an add-on component to a machine leaning network or deep neural network (DNN) that is configured for image and/or audio recognition or video analysis.

At step/operation 204, the method 200 includes receiving, by the adversarial detection machine learning component, input data. In some implementations, the input data is provided by an external system (e.g., image/audio recognition or video analysis system) and/or machine learning model(s), such as one or more DNNs (e.g., DNNs 107).

At step/operation 206, the method 200 includes observing, by applying layer regression operations, internal changes to a subset of layers of the adversarial detection machine learning component caused by the input data (e.g., based on the effect of the input data on the subset of layers as the input data propagates through a DNN).

Referring now to FIG. 2B, an example method 201 illustrating additional/sub-operations that include the proposed layer regression operations is provided.

At step/operation 203, the method 201 includes selecting a subset of layers of the adversarial detection machine learning component, for example, randomly and/or based on certain constraints. In some embodiments, the subset of layers are selected from intermediate and/or succeeding layers of the plurality of layers of the adversarial detection machine learning component to account for the fact that the impact of adversarial samples is usually higher on the succeeding layers (e.g., final layers) than preceding layers (e.g., early layers).

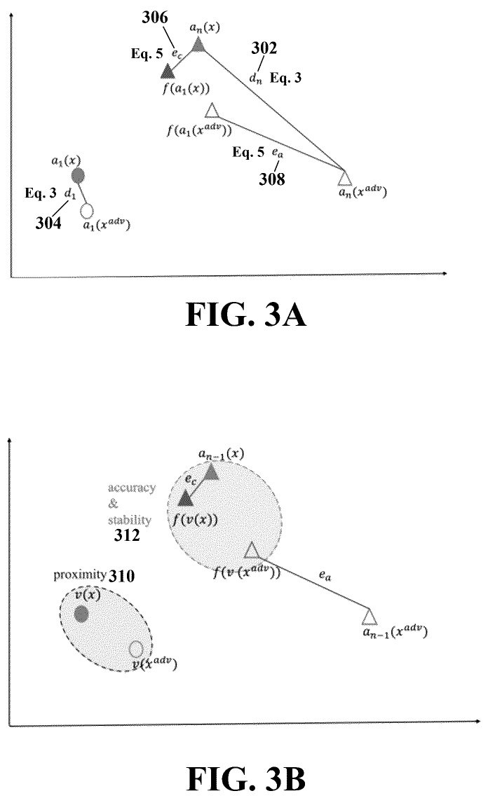

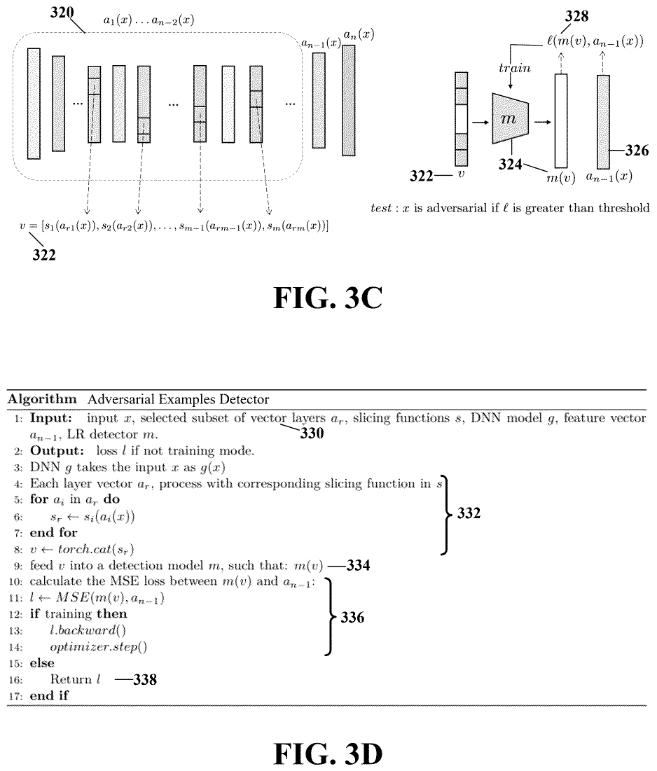

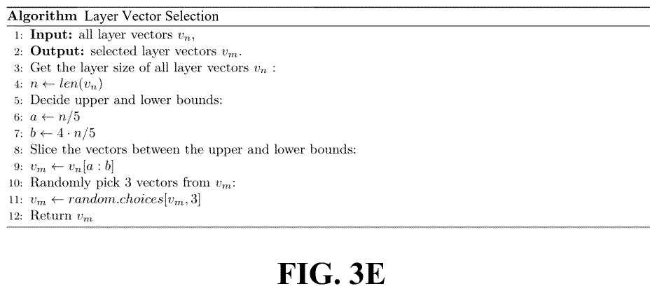

At step/operation 205, the method 201 includes generating an output vector for each of a plurality of segments in a subset of layers of the adversarial detection machine learning component, for example using a slicing function as described in more detail in connection with FIG. 3C.

At step/operation 207, the method 201 includes generating a feature vector from the generated output vectors.

At step/operation 209, the method 201 includes predicting the behavior of the machine learning model using the generated feature vector. In some implementations, predicting the behavior of the machine learning model using the generated feature vector can include comparing a determined loss associated with the feature vector to a predetermined threshold, where the threshold is determined by calculating a corresponding loss for a set of clean inputs.

At step/operation 211, the method 201 includes comparing actual behavior of the machine learning model with the predicted behavior.

Returning to FIG. 2A, at step/operation 208, the method 200 includes determining whether the input data is adversarial or clean based on the observed internal changes.

Optionally, at step/operation 210, the method 200 includes generating a real-time alert and/or taking a corrective action in response to determining that the input data is adversarial. A real-time alert can prompt manual review or automated countermeasures. In some examples, adversarial inputs are logged/recorded for forensic analysis and further training of the DNN(s). Exemplary corrective actions can include rejecting the input, isolating the DNN(s), retraining the DNN(s), denoising or smoothing inputs to remove adversarial perturbations, removing or isolating the adversarial inputs, or modifying/conditioning the input data (e.g., applying randomization techniques such as resizing, cropping and/or editing) to eliminate adversarial patterns.

### Example Method for Adversarial Examples Detection

A Deep Neural Network (DNN) model, denoted as g(·), can take an input x and predict a target variable y with g(x). There are three state-of-the-art defense methods against adversarial attacks for the DNN model: adversarial training, modifying input, and detecting adversarial samples by monitoring changes in output with respect to a baseline. While the former two focus on the changes in the input (clean input x vs. adversarial input x^{adv}), the latter utilizes the changes in the output (clean output g(x) vs. adversarial output g(x^{adv})). The exemplary detection system and method differ from the state-of-the-art methods by leveraging the nonuniform changes among different DNN layer activations. Instead of analyzing the adversarial input x^{adv} or the adversarial output g(x^{adv}), the exemplary detection system and method analyze the intermediate steps between x^{adv} and g(x^{adv}).

Adversarial Examples Estimation (eₐ). Although various attacks have different approaches to generate adversarial examples, they all aim to change the DNN model's prediction by maximizing the loss L (e.g., cross-entropy loss) between prediction g(x^{adv}) and a one-hot encoded ground truthy while limiting the perturbation, as shown in Equation 1.

$${max}_{{x}^{adv}} L ( g ( {x}^{adv} ) , y ) s . t . {‖ {x}^{adv} - x ‖}_{∞} \leq ϵ \qquad ( Eq . 1 )$$

In Equation 1, ϵ is the amount of perturbation on adversarial examples.

Considering the configuration “start with a small perturbation and end up with a big one” of the attacks and the sequential nature of DNN models, the impact of adversarial examples on the final layer can be higher than on the initial layer (see Equation 3). The DNN model g(·) can include n layers, denoted as a={a₁, a₂, . . . , aₙ}. In DNN models (e.g., CNNs, transformers, etc.), layers incrementally process the information from the previous layers to compute their respective outputs to the next layer. For example, for a model g where each layer is connected to the previous one, the final output of the model can be formulated per Equation 2.

$$g ( x ) = {a}_{n} ( {a}_{n - 1} ( … {a}_{1} ( x ) ) ) \qquad ( Eq . 2 )$$

A layer's output vector can be denoted as aᵢ(x). The output of the last layer, denoted as aₙ(x)=g(x), can be the class probability vector in classification tasks, and aₙ₋₁(x) can be referred to as the feature vector of the model. For an adversarial sample/input x^{adv}, the first layer output a₁(x^{adv}) can remain close to the clean version a₁(x) since the change in the input may be required to be unnoticeable by design, i.e., ∥x^{adv}−x∥_{∞}≤ϵ.

In the DNN model, the distance between aₙ(x) and aₙ(x^{adv}) can be larger than that between a₁(x) and a₁(x^{adv}), as shown in Equation 3. This is because (i) the first layer can be close (e.g., next to) to the input, for which the adversarial/perturbation impact is minimized, and far away from the final layer, for which the adversarial impact is maximized, and (ii) a₁(x^{adv}) can remain close to a₁(x) by design, as discussed above.

$${d}_{1} = {‖ {a}_{1} ( {x}^{a d v} ) - {a}_{1} ( x ) ‖}_{∞} < {d}_{n} = {‖ {a}_{n} ( {x}^{a d v} ) - {a}_{n} ( x ) ‖}_{∞} \qquad ( Eq . 3 )$$

In the DNN model, the first layer output a₁(x) can be mapped to the n^{th} layer output aₙ(x) using an estimation function ƒ (also referred to as an estimator ƒ) that satisfies Equation 4.

$${‖ f ( {a}_{1} ( x ) ) - f ( {a}_{1} ( x + ϵ ) ) ‖}_{∞} \leq δ for small ϵ and δ \qquad ( Eq . 4 )$$

Since ∥x^{adv}−x∥_{∞}≤ϵ in Equation 1 and a₁(x^{adv}) can stay close to a₁(x), ƒ(a₁(x^{adv})) can be close to ƒ(a₁(x)) due to the stability of ƒ. In Equation 3, aₙ(x^{adv}) is far away from aₙ(x) compared to the distance between a₁(x) and a₁(x^{adv}), so an estimation error for adversarial samples should be larger than the error for clean samples, as shown in Equation 5.

$${e}_{a} = {‖ f ( {a}_{1} ( {x}^{a d v} ) ) - {a}_{n} ( {x}^{a d v} ) ‖}_{∞} > {e}_{c} = {‖ f ( {a}_{1} ( x ) ) - {a}_{n} ( x ) ‖}_{∞} \qquad ( Eq . 5 )$$

FIG. 3A shows (i) an example impact of adversarial samples on the first and final layers of a DNN model and (ii) an example estimation error for adversarial and clean samples, in accordance with Equations 3 and 5. As shown, the impact of the adversarial samples is higher on the final layer (see 302) than on the first layer (see 304), and the error of a stable estimator ƒ is higher for adversarial samples (see 306) than for clean samples (see 308).

Layer-Regression Adversarial Examples Detector. When a suitable function ƒ is trained, Equation 5 can provide a system and method to detect adversarial samples. Four approximations can be made to obtain a detection algorithm (e.g., FIG. 3D) based on Equation 5. First, for computational efficiency and real-time detection in resource-constrained systems, a multilayer perceptron (MLP) can be used to approximate ƒ Second, since aₙ(x) denotes the predicted class probabilities, the feature vector aₙ₋₁, which takes unconstrained real values, can be chosen as the target to train the MLP as a regression model. Third, non-differentiable ∥·∥_{∞} can be approximated with ∥·∥₂ to train the MLP using the differentiable mean squared error (MSE) loss.

In deep neural networks with n>>1 (number of layers), training a suitable ƒ to estimate the feature vector aₙ₋₁ using the first layer output a₁ as the input may be challenging due to the highly nonlinear mapping in n-2 layers. To develop an adversarial examples detector via MLP, as the fourth approximation, a mixture of early-layer outputs (e.g., 5^{th}, 8^{th}, 13^{th} layers) can be selected as the input to the regression model instead of using only the first layer.

FIG. 3B shows an example estimation error of approximations by the exemplary detection system and method, which may depend on two conflicting objectives: (i) proximity 310 of input vectors for clean and adversarial samples and (ii) accuracy and stability 312 of the estimator ƒ.

FIG. 3C shows an example detection system and method for adversarial examples (also referred to as an adversarial examples detector). FIG. 3D shows an example algorithmic implementation of the exemplary detection system and method in FIG. 3C.

In FIGS. 3C-3D, utilizing the four approximations to Equation 5, the adversarial examples detection system and method (i.e., adversarial examples detector) are configured to (i) select, at step 330, a subset of the first n-2 layer vectors (see 320) and generate, at step 332, a new vector v (see 322) from the selected subset, (ii) feed v (see 322), at step 334, into a regression model m (see 324) to predict the feature vector aₙ₋₁(x) (see 326), (iii) train m (see 324), at step 336, by minimizing the mean squared error (MSE) loss [symbol] (m(v), aₙ₋₁(x)) (see 328) in a clean training set devoid of adversarial samples, and (iv) use [symbol] (m(v), aₙ₋₁(x)) (see 328), at step 338, as a detection score. The regression model m (see 324) may produce low scores for clean inputs and high scores for adversarial inputs.

The vector v (e.g., 322, FIG. 3C) can be formed in various ways, such as using only the i^{th} layer vector v=aᵢ(x) or a mixture of several layer vectors (e.g., ⅕ and ⅘ of all layers, FIG. 3E). To enable larger estimation error eₐ for adversarial samples than estimation error e_{c} for clean samples, the choice for v should strike a balance between two competing goals: proximity of clean v(x) and adversarial v(x^{adv}), and accuracy and stability of estimation function ƒ (see FIG. 3B). While training an accurate and stable regression model is more feasible when v is selected from the layers closer to the target layer n-1 (e.g., v=aₙ₋₂(x)), the adversarial examples detector may be less sensitive to adversarial samples since both aₙ₋₂(x) and aₙ₋₁(x) may be impacted by the attack, i.e., aₙ₋₂(x) and aₙ₋₂(x^{adv}) may not be proximal. On the other hand, selecting v=a₁(x) ensures a small perturbation in v, but also makes obtaining an accurate and stable estimator challenging. As a result, a subset of layer vectors (e.g., 320, FIG. 3C) to be selected by the exemplary system and method (e.g., 330, FIG. 3D) should be defined per Equation 6.

$${a}_{r} = \{ {a}_{r 1} ( x ) , {a}_{r 2} ( x ) , … , {a}_{r m} ( x ) \} \qquad ( Eq . 6 )$$

In Equation 6, aᵣ ∈a and m<n is the number of selected layers. From the selected layer vectors, a new vector v may be generated. However, since the layer vectors may be large (e.g., due to convolutions or attentions), to get a specific portion of the selected layer vectors, a slicing function s={s₁, s₂, . . . , sₘ} can be defined for each layer vector in aᵣ. Then, each slicing function can be applied to the corresponding layer vector in aᵣ to get the sliced vectors sᵣ, as shown in Equation 7 (e.g., 332, FIG. 3D).

$${s}_{r} = \{ {s}_{1} ( {a}_{r 1} ( x ) ) , {s}_{2} ( {a}_{r 2} ( x ) ) , … , {s}_{m} ( {a}_{r m} ( x ) \} \qquad ( Eq . 7 )$$

Finally, the vector v (e.g., 322, FIG. 3C) can be generated by concatenating the vectors in sᵣ, as shown in Equation 8 (e.g., 332, FIG. 3D).

$$v = [ {s}_{1} ( {a}_{r 1} ( x ) ) , {s}_{2} ( {a}_{r 2} ( x ) ) , … , {s}_{m} ( {a}_{r m} ( x ) ) ] \qquad ( Eq . 8 )$$

The order of sᵢ(aᵣᵢ(x)) in v can be randomized in inference to counteract adaptive attacks. The layer selection and slicing process (see Equations 6 and 7) are summarized in FIG. 3C. During the training, only the clean input samples are used. After the training, the loss may be low for clean inputs and high for adversarial inputs.

FIG. 3E shows an example algorithm for randomly selecting three-layer vectors between ⅕ and ⅘ of all layers in the DNNs.

### Example Machine Learning (ML) and Artificial Intelligence (AI) Models

Machine Learning. In addition to the machine learning operation described above, the exemplary system and method can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as a feature or features) to an output (also known as a target) during training with a labeled data set (or dataset). In an unsupervised learning model, the algorithm discovers patterns in the data. In a semi-supervised model, the model learns a function that maps an input (also known as a feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model.

A graph neural network (GNN) is a type of ANN that is configured to process graphical representations (i.e., graphs) of data/information. A graph is a structure comprising nodes where graph edges describe relationships between nodes. A graph can be described as G=(V, E) where G is the graph, V is a plurality of nodes, and E is a plurality of edges connecting the plurality of nodes. GNNs transmit information via a message passing mechanism where nodes aggregate information from their neighbors to update their representations (feature vectors) at each layer of the GNN. The GNN generates embeddings (n-dimensional vectors) for nodes that account for the node's features and the overall GNN structure.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression classifier is a supervised classification model that uses the logistic function to predict the probability of a target, which can be used for classification. logistic regression classifiers are trained with a data set (also referred to herein as a “dataset”) to maximize or minimize an objective function, for example, a measure of the logistic regression classifier's performance (e.g., error such as L1 or L2 loss), during training. This disclosure contemplates that any algorithm that finds the minimum of the cost function can be used. Logistic regression classifiers are known in the art and are therefore not described in further detail herein.

### Experimental Results and Additional Examples

A study was conducted to develop and evaluate an experimental detection system and method (i.e., adversarial examples detector), as described in relation to FIGS. 1-3E.

Experimental Datasets. The study chose 10,000 images from the ImageNet validation dataset and 10,000 images from the CIFAR-100 test dataset to evaluate (i) the experimental detector and (ii) the baseline defense methods. The study also used the area under the receiver operating characteristic (AUROC) curve to evaluate the attack detection performance of the defense methods. Similar to Zhang et al. (2023), the study conducted the evaluation on adversarial and clean sets. The clean set included all images correctly classified by the target DNN models. The adversarial set was formed for each attack-target model combination by gathering the attack's adversarial images misclassified by the target model.

Baseline Methods. The study benchmarked the experimental detector against baseline methods, including joint photographic experts group compression (JPEG) (Das et al., 2018), randomization (Random) (Xie et al., 2017), deflection (Deflect) (Prakash et al., 2018), feature squeezing (FS) Xu (2017a), wavelet denoising (Denoise) and super resolution (WDSR) (Mustafa et al., 2019), vision-language attack detection (VLAD) (Mumcu & Yilmaz, 2024c), and expected perturbation score-based adversarial detection (EPS-AD) (Zhang et al., 2023). Since FS, VLAD, and EPS-AD were developed as detectors, the study used their official implementations. The remaining baseline methods were developed to increase robustness by altering the inputs to remove perturbations, so the study derived a detection method from them by comparing the predictions before and after they were applied. A prediction match indicated no attack, and a prediction mismatch indicated an attack.

Target DNN Models. The study conducted the experiments using the ImageNet validation dataset (Russakovsky et al., 2015) and the CIFAR-100 dataset (Krizhevsky et al., 2009). To represent the different architectures, the study used (i) 3 Convolutional-Neural-Network-based (CNN-based) image classification models, including VGG19 (Simonyan & Zisserman, 2014), ResNet50 (He et al., 2015), InceptionV3 (Szegedy et al., 2015), and (ii) 3 transformer-based models, including ViT (Dosovitskiy, 2020), DeiT (Touvron et al., 2021), and LeViT (Graham et al., 2021).

Attack Methods. The study evaluated the experimental detector under an untargeted I_{∞} attack setting. The study used two threat models in the evaluation: a white-box static attack setting and an adaptive attack setting. The white-box static attack setting is where the attacker has complete knowledge of the classifier but not the detector. Strong attacks from previous studies, including basic iterative method (BIM) (Kurakin et al., 2018), projected gradient descent (PGD) (Madry et al., 2017), patch-wise iterative fast (PIF) (Gao et al., 2020), auto projected gradient descent (APGD) (Croce & Hein, 2020b), adaptive noise distribution attack (ANDA) (Fang et al., 2024), variance-minimizing iterative (VMI), and variance-normalizing iterative (VNI) (Wang & He, 2021) attacks were used as white-box attacks. The study also tested the experimental detector against an ensemble white-box attack, e.g., AutoAttack (AA) (Croce & Hein, 2020a).

The adaptive attack setting is where the attacker also has full knowledge of the defense mechanism. The study analyzed the performance of the experimental detector against an adaptive attack (Yang et al., 2022) trained to deceive the target model and bypass the experimental detector simultaneously.

Layer Regression Training. For each model, an MLP with 2 hidden layers was trained as a layer regression (LR) detector to demonstrate that an effective detector can be built using a lightweight neural network with minimal computational overhead. After experimenting with different layer selection and slicing strategies, the study found that selecting only from early or final layers reduced the performance, but randomly selecting three layers and slicing the middle 60% portion of each selected layer yielded good results.

The study chose a subset of layer vectors aᵣ (see Equation 6) for each target model used during the experiments. Table 1 shows subsets of layers chosen for the target DNN models in the evaluation.

TABLE 1

| Target | |
|---|---|
| model | Chosen subset of layers |
| Resnet50 | The study filtered layers with the name conv2. Then, among 15 conv2 layers, |
| | the study chose the 5^{th}, 8^{th}, and 13^{th} layers for all ImageNet and CIFAR-100 |
| | tests. |
| InceptionV3 | The study filtered layers with the name conv. Then, among 94 conv layers, the |
| | study chose the 15^{th}, 25^{th}, and 35^{th} layers for all ImageNet and CIFAR-100 tests. |
| VGG19 | The study filtered layers with the name features. Then, among 37 features |
| | layers, the study chose the 8^{th}, 13^{th}, and 17^{th} layers for all ImageNet and CIFAR- |
| | 100 tests. |
| ViT | The study filtered layers with the name attn.proj. Then, among 23 attn.proj |
| | layers, the study chose the 8^{th}, 13^{th}, and 17^{th} layers for all ImageNet and CIFAR- |
| | 100 tests. |
| DeiT | The study filtered layers with the name attn.proj. Then, among 24 attn.proj |
| | layers, the study chose (i) the 8^{th}, 13^{th} and 17^{th} layers for ImageNet tests, and (ii) |
| | the 5^{th}, 6^{th}, and 7^{th} layers for CIFAR-100 tests. |
| LeViT | The study filtered layers with the name attn.proj. Then, among 12 attn.proj |
| | layers, the study chose (i) the 3^{rd}, 5^{th}, and 7^{th} layers for ImageNet tests, and (ii) |
| | the 5^{th}, 6^{th}, and 7^{th} layers for CIFAR-100 tests. |

Before concatenating the aᵣ vectors derived from the target DNN models, the study applied a slicing function (see Equation 7) to each vector. Table 2 shows the slicing functions for corresponding vectors aᵣ derived from Table 1.

TABLE 2

| Target | |
|---|---|
| model | Slicing functions for each aᵣ derived from Table 1 |
| Resnet50 | [: 5, : 28, : 28], [: 50, : 7, : 7], and [: 10, : 14, : 14] |
| InceptionV3 | [: 3, : 35, : 35], [3 :, 35 :, 35], and [: 3, : 17, : 17] |
| VGG19 | [: 5, : 25, : 25], [: 5, : 25, : 25], and [: 5, : 25, : 25] |
| ViT | [:, : 4 : 200], [:, : 4 : 200], and [:, : 4 :, 200] |
| DeiT | [:, : 4, : 200], [:, : 4, : 200], and [:, : 4, : 200] |
| LeViT | [: 4, : 14 :, 14], [: 14, : 7, : 7], and [: 14, : 7, : 7] |

The vector v was then generated by concatenating the sliced aᵣ vectors (see Equation 8). After acquiring v for a model, an MLP with two hidden layers was trained to minimize the MSE loss between v and the feature vector aₙ₋₁. Adam optimizer with 3·10⁻⁴ learning rate was used for the training.

White-Box Static Attacks Detection. Table 3 shows the AUROC scores for various defense methods (e.g., JPEG, Random, Deflect, Denoise, WDSR, FS, and the experimental detector) evaluated against 7 adversarial attacks (e.g., BIM, PGD, PIF, APGD, ANDA, VMI, and VNI) targeting 6 DNN models (e.g., VGG19, ResNet50, InceptionV3, ViT, DeiT, and LeViT) across ImageNet and CIFAR-100 datasets. In every experimental setting, with different attacks, target DNN models, and datasets, the experimental detector outperformed the baseline defense methods by a wide margin. Compared to LR's average AUROC score of 0.98, the best performance among the current methods remained at 0.64. The experimental detector was robust across varying target DNN models and attack types, as indicated by its small standard deviation. While the baseline defense methods were effective against certain target-attack combinations, they failed to generalize this to various settings. For instance, on the ImageNet dataset, JPEG, Random, and FS performed better with transformer models; however, they rarely exceeded the random guess performance with the CNN models.

TABLE 3

| | | | | | | | | Experimental |
|---|---|---|---|---|---|---|---|---|
| | | JPEG | Random | Deflect | Denoise | WDSR | FS | detector |
| | | ImageNet dataset | | | | | | |
| VGG19 | BIM | 0.42 | 0.43 | 0.48 | 0.45 | 0.39 | 0.13 | 0.99 |
| | PGD | 0.50 | 0.46 | 0.48 | 0.45 | 0.46 | 0.22 | 0.99 |
| | PIF | 0.33 | 0.44 | 0.48 | 0.45 | 0.31 | 0.08 | 0.99 |
| | APGD | 0.53 | 0.46 | 0.48 | 0.45 | 0.49 | 0.23 | 0.99 |
| | ANDA | 0.39 | 0.47 | 0.49 | 0.47 | 0.38 | 0.26 | 0.95 |
| | VMI | 0.36 | 0.42 | 0.48 | 0.45 | 0.34 | 0.11 | 0.99 |
| | VNI | 0.41 | 0.45 | 0.48 | 0.46 | 0.38 | 0.19 | 0.99 |
| ResNet50 | BIM | 0.67 | 0.63 | 0.49 | 0.48 | 0.55 | 0.29 | 0.99 |
| | PGD | 0.77 | 0.75 | 0.49 | 0.49 | 0.68 | 0.53 | 0.98 |
| | PIF | 0.51 | 0.64 | 0.49 | 0.48 | 0.47 | 0.29 | 0.96 |
| | APGD | 0.75 | 0.70 | 0.49 | 0.49 | 0.64 | 0.47 | 0.97 |
| | ANDA | 0.45 | 0.48 | 0.49 | 0.48 | 0.44 | 0.14 | 0.96 |
| | VMI | 0.49 | 0.52 | 0.49 | 0.48 | 0.45 | 0.14 | 0.99 |
| | VNI | 0.53 | 0.54 | 0.49 | 0.49 | 0.47 | 0.21 | 0.97 |
| InceptionV3 | BIM | 0.55 | 0.53 | 0.50 | 0.49 | 0.77 | 0.24 | 0.98 |
| | PGD | 0.62 | 0.58 | 0.50 | 0.49 | 0.80 | 0.36 | 0.97 |
| | PIF | 0.48 | 0.52 | 0.50 | 0.49 | 0.67 | 0.11 | 0.99 |
| | APGD | 0.60 | 0.56 | 0.50 | 0.50 | 0.79 | 0.36 | 0.96 |
| | ANDA | 0.49 | 0.50 | 0.50 | 0.49 | 0.52 | 0.23 | 0.92 |
| | VMI | 0.48 | 0.50 | 0.50 | 0.49 | 0.67 | 0.12 | 0.98 |
| | VNI | 0.52 | 0.53 | 0.50 | 0.50 | 0.70 | 0.25 | 0.96 |
| ViT | BIM | 0.87 | 0.90 | 0.53 | 0.64 | 0.82 | 0.93 | 0.99 |
| | PGD | 0.85 | 0.87 | 0.53 | 0.60 | 0.79 | 0.91 | 0.99 |
| | PIF | 0.79 | 0.82 | 0.52 | 0.51 | 0.67 | 0.87 | 0.99 |
| | APGD | 0.86 | 0.90 | 0.53 | 0.63 | 0.80 | 0.92 | 0.99 |
| | ANDA | 0.72 | 0.68 | 0.52 | 0.56 | 0.64 | 0.82 | 0.97 |
| | VMI | 0.77 | 0.81 | 0.51 | 0.57 | 0.70 | 0.86 | 0.99 |
| | VNI | 0.78 | 0.83 | 0.52 | 0.61 | 0.73 | 0.91 | 0.99 |
| DeiT | BIM | 0.86 | 0.89 | 0.52 | 0.58 | 0.78 | 0.88 | 0.99 |
| | PGD | 0.86 | 0.88 | 0.53 | 0.58 | 0.80 | 0.90 | 0.99 |
| | PIF | 0.77 | 0.84 | 0.51 | 0.50 | 0.71 | 0.62 | 0.99 |
| | APGD | 0.85 | 0.90 | 0.52 | 0.57 | 0.78 | 0.88 | 0.99 |
| | ANDA | 0.77 | 0.76 | 0.53 | 0.58 | 0.70 | 0.75 | 0.99 |
| | VMI | 0.79 | 0.84 | 0.51 | 0.53 | 0.69 | 0.80 | 0.99 |
| | VNI | 0.80 | 0.85 | 0.52 | 0.55 | 0.72 | 0.85 | 0.99 |
| LeViT | BIM | 0.68 | 0.73 | 0.50 | 0.50 | 0.62 | 0.64 | 0.99 |
| | PGD | 0.69 | 0.74 | 0.50 | 0.49 | 0.62 | 0.66 | 0.99 |
| | PIF | 0.54 | 0.65 | 0.50 | 0.49 | 0.49 | 0.51 | 0.99 |
| | APGD | 0.75 | 0.80 | 0.50 | 0.51 | 0.69 | 0.76 | 0.98 |
| | ANDA | 0.49 | 0.51 | 0.50 | 0.49 | 0.49 | 0.43 | 0.94 |
| | VMI | 0.53 | 0.59 | 0.50 | 0.49 | 0.48 | 0.39 | 0.99 |
| | VNI | 0.60 | 0.66 | 0.50 | 0.51 | 0.54 | 0.59 | 0.99 |
| | Average | 0.63 | 0.66 | 0.50 | 0.51 | 0.61 | 0.50 | 0.99 |
| | | CIFAR-100 dataset | | | | | | |
| VGG19 | BIM | 0.47 | 0.31 | 0.49 | 0.48 | 0.41 | 0.01 | 0.99 |
| | PGD | 0.48 | 0.31 | 0.49 | 0.48 | 0.44 | 0.02 | 0.99 |
| | PIF | 0.47 | 0.31 | 0.49 | 0.48 | 0.41 | 0.01 | 0.99 |
| | APGD | 0.48 | 0.32 | 0.49 | 0.48 | 0.42 | 0.02 | 0.99 |
| | ANDA | 0.48 | 0.36 | 0.49 | 0.49 | 0.43 | 0.11 | 0.99 |
| | VMI | 0.47 | 0.32 | 0.49 | 0.48 | 0.41 | 0.01 | 0.99 |
| | VNI | 0.47 | 0.32 | 0.49 | 0.48 | 0.42 | 0.02 | 0.99 |
| ResNet50 | BIM | 0.82 | 0.69 | 0.46 | 0.62 | 0.73 | 0.39 | 0.98 |
| | PGD | 0.87 | 0.71 | 0.45 | 0.71 | 0.82 | 0.40 | 0.99 |
| | PIF | 0.73 | 0.72 | 0.45 | 0.48 | 0.61 | 0.63 | 0.97 |
| | APGD | 0.84 | 0.65 | 0.46 | 0.62 | 0.78 | 0.44 | 0.96 |
| | ANDA | 0.56 | 0.53 | 0.45 | 0.48 | 0.45 | 0.07 | 0.99 |
| | VMI | 0.61 | 0.58 | 0.45 | 0.50 | 0.50 | 0.23 | 0.99 |
| | VNI | 0.62 | 0.55 | 0.45 | 0.50 | 0.51 | 0.28 | 0.97 |
| InceptionV3 | BIM | 0.88 | 0.80 | 0.43 | 0.74 | 0.81 | 0.36 | 1.00 |
| | PGD | 0.86 | 0.66 | 0.43 | 0.76 | 0.81 | 0.32 | 0.99 |
| | PIF | 0.82 | 0.89 | 0.44 | 0.57 | 0.72 | 0.34 | 1.00 |
| | APGD | 0.88 | 0.82 | 0.43 | 0.77 | 0.81 | 0.38 | 0.99 |
| | ANDA | 0.71 | 0.57 | 0.43 | 0.50 | 0.59 | 0.29 | 0.99 |
| | VMI | 0.85 | 0.78 | 0.42 | 0.50 | 0.80 | 0.35 | 1.00 |
| | VNI | 0.86 | 0.79 | 0.43 | 0.60 | 0.81 | 0.31 | 1.00 |
| ViT | BIM | 0.50 | 0.66 | 0.50 | 0.50 | 0.49 | 0.29 | 0.98 |
| | PGD | 0.49 | 0.67 | 0.50 | 0.50 | 0.48 | 0.27 | 0.97 |
| | PIF | 0.49 | 0.53 | 0.50 | 0.49 | 0.48 | 0.15 | 0.98 |
| | APGD | 0.50 | 0.71 | 0.50 | 0.50 | 0.50 | 0.32 | 0.95 |
| | ANDA | 0.49 | 0.52 | 0.50 | 0.50 | 0.48 | 0.26 | 0.85 |
| | VMI | 0.49 | 0.58 | 0.50 | 0.49 | 0.48 | 0.15 | 0.99 |
| | VNI | 0.50 | 0.60 | 0.50 | 0.50 | 0.49 | 0.27 | 0.95 |
| DeiT | BIM | 0.50 | 0.64 | 0.50 | 0.49 | 0.48 | 0.36 | 0.92 |
| | PGD | 0.50 | 0.66 | 0.50 | 0.49 | 0.48 | 0.34 | 0.87 |
| | PIF | 0.48 | 0.52 | 0.50 | 0.49 | 0.47 | 0.16 | 0.97 |
| | APGD | 0.50 | 0.65 | 0.50 | 0.50 | 0.48 | 0.36 | 0.91 |
| | ANDA | 0.49 | 0.51 | 0.50 | 0.49 | 0.48 | 0.26 | 0.91 |
| | VMI | 0.49 | 0.56 | 0.50 | 0.49 | 0.48 | 0.30 | 0.96 |
| | VNI | 0.49 | 0.57 | 0.50 | 0.50 | 0.48 | 0.28 | 0.94 |
| LeViT | BIM | 0.93 | 0.83 | 0.68 | 0.88 | 0.86 | 0.98 | 0.99 |
| | PGD | 0.93 | 0.84 | 0.57 | 0.84 | 0.85 | 0.86 | 0.93 |
| | PIF | 0.86 | 0.82 | 0.50 | 0.53 | 0.80 | 0.62 | 0.93 |
| | APGD | 0.93 | 0.83 | 0.68 | 0.88 | 0.86 | 0.98 | 0.99 |
| | ANDA | 0.84 | 0.71 | 0.52 | 0.57 | 0.81 | 0.65 | 0.93 |
| | VMI | 0.93 | 0.83 | 0.66 | 0.66 | 0.86 | 0.98 | 0.99 |
| | VNI | 0.92 | 0.83 | 0.67 | 0.71 | 0.86 | 0.99 | 0.99 |
| | Average | 0.65 | 0.62 | 0.50 | 0.56 | 0.60 | 0.35 | 0.97 |

Due to the high computational requirements of VLAD and EPS-AD, the study benchmarked these methods in a smaller setting, where 1,000 images and 3 target DNN models were used with the same 7 attacks. Table 4 shows the AUROC scores for VLAD, EPS-AD, and the experimental detector evaluated against 7 adversarial attacks (e.g., BI, PGD, PIF, APGD, ANDA, VMI, and VNI) targeting 3 DNN models (e.g., VGG19, ResNet50, and ViT) across the ImageNet dataset. In all test cases, VLAD had an average AUROC score of 0.88. VLAD performed worst against the attacks targeted at ResNet50, where its performance varied between 0.82 and 0.77. On the other hand, similar to the results in Table 3, the experimental detector proved its robustness against different attack and target combinations with the average AUROC score of 0.99. EPS-AD performed similarly to the experimental detector, where EPS-AD detected attacks with an average AUROC score of 00.99. However, compared to the experimental detector, both VLAD and EPS-AD had large computational costs, limiting their real-world usage.

TABLE 4

| | | BIM | PGD | PIF | APGD | ANDA | VMI | VNI |
|---|---|---|---|---|---|---|---|---|
| VGG19 | VLAD | 0.94 | 0.94 | 0.96 | 0.96 | 0.93 | 0.93 | 0.95 |
| | EPS-AD | 0.99 | 0.97 | 0.97 | 0.99 | 0.98 | 0.99 | 0.99 |
| | Experimental | 0.99 | 0.99 | 0.99 | 0.99 | 0.99 | 0.99 | 0.99 |
| | detector | | | | | | | |
| ResNet | VLAD | 0.81 | 0.81 | 0.81 | 0.82 | 0.77 | 0.80 | 0.80 |
| | EPS-AD | 0.99 | 0.98 | 0.98 | 0.99 | 0.99 | 0.99 | 0.99 |
| | Experimental | 0.99 | 0.99 | 0.98 | 0.97 | 0.96 | 0.99 | 0.97 |
| | detector | | | | | | | |
| ViT | VLAD | 0.94 | 0.92 | 0.89 | 0.93 | 0.85 | 0.93 | 0.91 |
| | EPS-AD | 0.99 | 0.97 | 0.98 | 0.99 | 0.99 | 0.99 | 0.99 |
| | Experimental | 0.99 | 0.99 | 0.99 | 0.99 | 0.99 | 0.99 | 0.99 |
| | detector | | | | | | | |

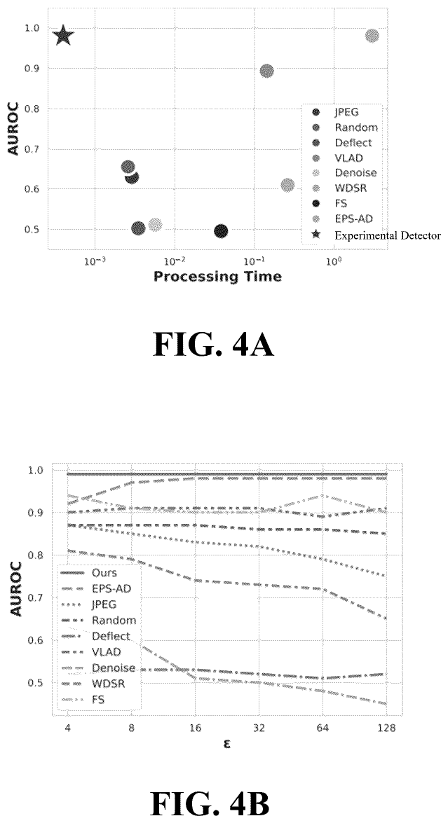

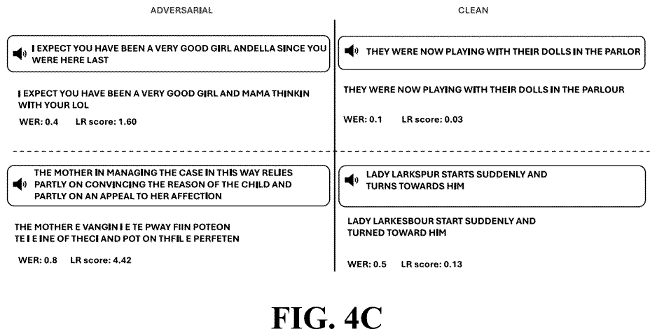

Computational Efficiency. Real-time attack detection is a crucial aspect of many real-world systems. A detector should operate consistently alongside the DNN model to ensure timely identification of adversarial examples, so a detector should be computationally efficient. The study compared the computational costs of the defense methods evaluated in the experiments. For each defense method, the study processed 1,000 samples from the ImageNet dataset and calculated the average processing time per sample. FIG. 4A shows the processing time per sample (PTS) in seconds vs. AUROC for each defense method. As shown, the experimental detector was the fastest, with a PTS of 0.0004 seconds. In contrast, VLAD, WSDR, and EPS-AD were the slowest, with PTS values of 0.1431, 0.2611, and 2.9998 seconds, respectively. The experimental detector demonstrated the best detection performance and was the fastest. The experimental detector ran 1.3×106 times faster than EPS-AD, which achieved similar detection performance to the experimental detector. The study measured the processing times using a desktop computer with an NVIDIA 4090 GPU, AMD Ryzen 9 7950X CPU, and 64 GB RAM.

Performance under Varying Attack Strength. Adversarial attacks may use a parameter ϵ to adjust the amount of perturbation on adversarial examples. The study evaluated the performance of the defense methods against PGD attack with different E values, including 4, 8, 16, 32, 64, and 128. FIG. 4B shows the performances of defense methods (e.g., experimental detector, EPS-AD, JPEG, Random, Deflect, VLAD, Denoise, WDSR, FS) against the ViT-PGD model-attack pair. As shown, the experimental detector performed the same for every c value. Since the experimental detector's layer regression (LR) depended on the perturbation's effects on DNN layers, a performance drop did not occur in the experimental detector due to the changes in attack strength. EPS-AD performed lower on weaker attacks, as its performance dropped when E was 4. In the remaining defense methods, while VLAD and Deflect experienced only small changes under stronger attacks, the others were notably affected by the c value.

Performance against Adaptive Attacks. AutoAttack is an ensemble-based method combining multiple attacks that can be used as an adaptive attack to evaluate detectors. Table 5 shows the performance of the experimental detector against the AutoAttack targeting 6 DNN models, including VGG19, ResNet, IncV3, ViT, DeiT, and LeVit. Similar to the results in Tables 3 and 4, the experimental detector performed with an average of 0.98% AUROC score.

TABLE 5

| Model | VGG19 | ResNet | IncV3 | ViT | DeiT | LeVit |
|---|---|---|---|---|---|---|
| AUROC | 0.99 | 0.97 | 0.96 | 0.99 | 0.99 | 0.98 |

Since AutoAttack did not use any knowledge of the experimental detector, the study developed a PGD-based targeted adaptive attack, following a similar approach to (Yang et al., 2022), with an objective function defined per Equation 10.

$$max {L}_{Classifier} - λ \cdot {L}_{L R} \qquad ( Eq . 10 )$$

In Equation 10, L_{Classifier} and L_{LR} denote the loss functions of the target model and the experimental detector (i.e., experimental RL detector), respectively. The sign of L_{LR} is negative since the experimental detector identifies an input as clean when the loss is low. Since the PGD-based targeted adaptive attack model had complete knowledge of the experimental detector, it was challenging and destructive for the experimental detector. To address this challenge, the study configured randomly concatenating the layer vectors (see Equation 8) at inference time.

Table 6 shows the performance of the experimental detector against the PGD-based adaptive attack with varying strengths ϵ (e.g., ϵ∈[4, 8, 16, 32, 64, 128]), where λ (see Equation 10) was 1. As shown, with the target model being ViT, the experimental setting having the number of iterations of 200 (Yang et al., 2022), and λ being 1, the experimental detector achieved an average AUROC score of 80%, even against this destructive adaptive threat model.

TABLE 6

| ∈ | 4 | 8 | 16 | 32 | 64 | 128 |
|---|---|---|---|---|---|---|
| AUROC | 0.81 | 0.78 | 0.79 | 0.80 | 0.81 | 0.81 |

Performance against I₂ and Targeted Attacks. Table 7 shows the performance of the experimental detector under I₂ and targeted attack settings, including PGD_{targeted}, PGDₗ_{₂}, APGD_{targeted}, and APGDₗ_{₂} attacks, using target models ResNet50 and ViT on the ImageNet dataset. Similar to the white-box attack setting, the experimental detector performed an average AUROC score of 97%, further demonstrating the success of the experimental detector in detecting various types of attacks.

TABLE 7

| | PGD_{targeted} | PGDₗ_{₂} | APGD_{targeted} | APGDₗ_{₂} |
|---|---|---|---|---|
| ResNet50 | 0.99 | 0.95 | 0.98 | 0.95 |
| ViT | 0.99 | 0.95 | 0.98 | 0.96 |

Applicability in other Domains. The experimental detector was applicable in various domains where DNNs were used. The study demonstrated the performance of the experimental detector in 3 additional domains, including video action recognition, speech recognition, and traffic sign recognition.

The study used the experimental detector against video action recognition attacks and compared its performance to baseline defense methods configured for action recognition models, including adversarial frames identifier based on temporal consistency in videos (Advit) (Xiao et al., 2019), Shuffle (Hwang et al., 2023), and VLAD (Mumcu & Yilmaz, 2024c). In the evaluation, the study used PGD-v attack (Mumcu & Yilmaz, 2024c) and Flick attack (Pony et al., 2021) to target two video action recognition models, including MVIT (Fan et al., 2021) and X3D (Feichtenhofer, 2020). The study used the experimental settings in Mumcu & Yilmaz (2024c) on the Kinetics-400 (Kay et al., 2017) dataset. Table 8 shows the AUROC scores of the defense methods (e.g., experimental detector, Advit, Shuffle, VLAD) against attacks (e.g., PGD-v, Flick) targeting video action recognition models (e.g., MVIT, X3D). As shown, the experimental detector outperformed the other defense methods with an average AUROC of 0.93%, followed by VLAD with 0.91%.

TABLE 8

| | | | | | Experimental |
|---|---|---|---|---|---|
| | | Advit | Shuffle | VLAD | detector |
| MVIT | PGD-v | 0.93 | 0.98 | 0.93 | 0.99 |
| | Flick | 0.34 | 0.65 | 0.87 | 0.89 |
| X3D | PGD-v | 0.92 | 0.76 | 0.97 | 0.95 |
| | Flick | 0.54 | 0.59 | 0.90 | 0.92 |
| | Average | 0.68 | 0.74 | 0.91 | 0.93 |

The study also evaluated the performance of the experimental detector against a speech recognition attack. The study used the Wav2vec (Schneider et al., 2019) model, trained on the LibriSpeech (Panayotov et al., 2015) dataset, as a speech recognition model. The study used the fast gradient sign method (FGSM) (Goodfellow et al., 2014) attack on the speech recognition model. The experimental detector achieved an average AUROC score of 0.99 against the FGSM attack.

FIG. 4C shows some attacked and clean samples for speech recognition (by Wav2vec model) with ground truth (in box), recognized text, word error rate (WER), and MSE values of the experimental detector. As shown, the experimental detector even detected stealthy attacks that caused a minimal increase in word error rate (WER) while distorting the recognized speech. While the WER of the first adversarial example (0.4) was lower than that of the second clean example (0.5), the MSE value (shown as LR score) for the stealthy adversarial sample (1.6) was more than tenfold greater than that of the second clean example (0.13).

The study also evaluated the experimental detector against attacks that target traffic sign recognition. In the evaluation, the study used ResNet50 as a target traffic sign recognition model and used FGSM (Goodfellow et al., 2014), PGD (Madry et al., 2017), Light (Hsiao et al., 2024), and Patch (Ye et al., 2021) attacks against ResNet50. Table 9 shows the AUROC score of the experimental detector against FGSM, PGD, Light, and Patch attacks that target ResNet50. As shown, the experimental detector achieved an average AUC score of 96%, further proving the applicability and success of the experimental detector across different domains.

TABLE 9

| | FGSM | PGD | Patch | Light | Average |
|---|---|---|---|---|---|
| Experimental | 0.97 | 0.99 | 0.95 | 0.94 | 0.96 |
| detector | | | | | |

### Additional Discussion

Deep neural networks (DNNs) are vulnerable to subtle and manipulative noise for input data instances designed by adversaries to cause erroneous outputs. Goodfellow et al. (2014) developed the Fast Gradient Sign Method (FGSM) to craft such adversarial instances by adding or subtracting a small perturbation to each input dimension based on the sign of the gradient. After FGSM, various adversarial sample generation methods were demonstrated across different domains. However, compared to the diversity among attack techniques, there are not enough studies that detect the increasing number of attacks in various domains.

There are two main current defense methods against adversarial attacks. The first current defense method aims to mitigate the effects of attacks (e.g., correctly classifying adversarial images) by developing robust DNNs less vulnerable to adversarial data. The second current defense method aims to detect and discard the adversarial data.

An effective defense method is adversarial training for robustness (Goodfellow et al, 2014) and detection (Grosse et al., 2017), in which the DNN is retrained using the known adversarial instances. Although effective against known attacks, adversarial training experiences a high computational cost for unseen attacks. Similarly, other current detection methods are only effective against some attacks. For instance, Metzen et al. (2017), in a supervised learning setup, trained a binary classifier for attack detection, which performed well on the attacks seen in training, but failed for the unseen attacks. A recent detector, EPS-AD (Zhang et al., 2023), detected unseen attacks by training only on natural data in a semi-supervised anomaly detection setup at the expense of a significant computational cost. Another recent detection method, VLAD (Mumcu & Yilmaz, 2024c), detected a wide range of attacks by training a secondary model only on natural data; however, VLAD was vulnerable to transferable attacks that affected its secondary baseline model.

The current adversarial data detectors in previous studies were configured for a specific application and do not extend to other applications, as they were based on domain-specific DNNs, e.g., adversarial image detection using convolutional neural networks (Metzen et al., 2017) or diffusion models (Zhang et al., 2023). Motivated by the lack of a computationally efficient detector that can detect a wide range of attacks in real-time, the exemplary detection system and method (i.e., adversarial examples detector) are developed to detect various attacks (e.g., adversarial attacks, etc.) on DNNs in various applications, including image recognition, video action recognition, and speech recognition.

Adversarial Attacks. The robustness of DNNs and their vulnerability to adversarial examples have been investigated since the introduction of FGSM (Goodfellow et al., 2014). Numerous adversarial attacks have been developed to generate adversarial examples in recent years (e.g., Madry et al., 2017; Croce & Hein, 2020b; Kurakin et al., 2018; Chen et al., 2017; Ilyas et al., 2018; Mumcu & Yilmaz, 2024a; Wang & He, 2021; Fang et al., 2024; Gao et al., 2020). There are two main adversarial attack settings, white-box and black-box. While an attacker may have access to the target model (e.g., DNN model) in the white-box setting, in the black-box setting, the attacker does not have any prior information about the target model.

White box attacks (also referred to as gradient-based attacks), including FGSM (Goodfellow et al., 2014), PGD (Madry et al., 2017), and APGD (Croce & Hein, 2020b), can generate adversarial examples by maximizing the target model's loss function. BIM (Kurakin et al., 2018) improved the gradient-based attack by applying perturbations iteratively. Transferability-based black-box attacks, developed by Papernot et al. (2017), are the common approaches in black-box adversarial settings. Transferability-based black-box attacks involve training a substitute model to mimic the behavior of an unknown target model, then generating adversarial examples using the substitute. The effectiveness of these adversarial examples relies on their ability to transfer across DNNs. While such adversarial examples are most successful when the substitute closely resembles the target model, as in white-box scenarios, they can still be effective even when there are architectural differences between the two models. Wang & He (2021) developed VMI and VNI to extend iterative gradient-based attacks and achieve high transferability by considering the gradient variance of the previous iterations. PIF (Gao et al., 2020) used patch-wise iterations to achieve transferability. ANDA (Fang et al., 2024) aimed to achieve strong transferability by avoiding overfitting adversarial examples to the substitute model. In addition, some approaches combine multiple attacks, such as AutoAttack (Croce & Hein, 2020a), to test the robustness of models against a diverse set of adversarial perturbations.

Adversarial Defenses. A common defense method against adversarial examples involves modifying the input data to reduce or eliminate the effects of perturbations. JPEG compression, developed in previous studies (Cucu et al., 2023; Aydemir et al., 2018; Das et al., 2018), shows that compressing and decompressing images can help mitigate adversarial effects. Similarly, Xie et al. (2017) applied random resizing and padding to inputs to disrupt adversarial patterns. Various denoising methods (Liao et al., 2018; Xiong et al., 2022; and Salman et al., 2020) have also been developed to remove adversarial noise from input data. Mustafa et al. (2019) combined wavelet denoising with image super-resolution as a preprocessing pipeline to defend against attacks. Prakash et al. (2018) developed pixel deflection, a technique that redistributes pixel values to reduce adversarial impact.

Adversarial training is another method to improve the robustness of DNNs. However, this method often struggles under diverse attack configurations (Bai et al., 2021). Papernot and McDaniel (2018) enhanced model robustness by applying k-nearest neighbors (kNN) classification to feature representations across different layers of a DNN. This method leverages the nonuniform impact of adversarial data on network layers, but is limited by its computational inefficiency and lack of universal applicability across architectures.

Recently, various detection methods have emerged. Xu (2017b) developed feature squeezing, which employs bit-depth reduction, spatial smoothing, and non-local means denoising to identify adversarial examples. Zhang et al. (2023) computed an Expected Perturbation Score (EPS), which averages a sample's behavior across multiple perturbations generated using a pre-trained diffusion model. Yang et al. (2022) developed a detection method to identify semantic contradictions by reconstructing inputs from internal feature representations. Pang et al. (2018) developed a training-time modification using reverse cross-entropy to enforce separable feature representations for clean and adversarial inputs, improving detection performance but requiring changes to the training process. Similarly, Tian et al. (2018) developed a method based on prediction consistency under image transformations, exploiting the instability of adversarial samples under rotation or translation.

A more recent defense method involves comparing the outputs of a target model with those of a baseline model (e.g., Vision-Language Models (VLMs)). The underlying assumption is that clean inputs produce similar outputs across models, while adversarial inputs result in divergent predictions. Mumcu and Yilmaz (2024c) demonstrated this method using contrastive language-image pretraining (CLIP) to detect adversarial examples in video data.

### Example Computing Device

Referring to FIG. 5, an example computing device 500 upon which embodiments of the invention may be implemented is illustrated. This disclosure contemplates that the controller(s) for operating the flexure elements and/or imaging apparatus can be implemented using a computing device 500. It should be understood that the example computing device 500 is only one example of a suitable computing environment upon which embodiments of the invention may be implemented. Optionally, the computing device 500 can be a well-known computing system, including, but not limited to, personal computers, servers, handheld or laptop devices, multiprocessor systems, microprocessor-based systems, personal network computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, the computing device 500 typically includes at least one processing unit 506 and system memory 504. Depending on the exact configuration and type of computing device, system memory 504 may be volatile (such as random-access memory (RAM)), non-volatile (such as read-only memory (ROM), flash memory, etc.), or some combination of the two. This most basic configuration is illustrated in FIG. 5 by the dashed line 502. The processing unit 506 may be a standard programmable processor that performs arithmetic and logic operations necessary for the operation of the computing device 500. The computing device 500 may also include a bus or other communication mechanism for communicating information among various components of the computing device 500.

Computing device 500 may have additional features/functionality. For example, the computing device 500 may include additional storage such as removable storage 508 and non-removable storage 510 including, but not limited to magnetic or optical disks or tapes. Computing device 500 may also contain network connection(s) 516 that allow the device to communicate with other devices. Computing device 500 may also have input device(s) 514 such as a keyboard, mouse, touch screen, etc. Output device(s) 512, such as a display, speakers, printer, etc., may also be included. The additional devices may be connected to the bus in order to facilitate the communication of data among the components of the computing device 500. All these devices are well-known in the art and need not be discussed at length here.

The processing unit 506 may be configured to execute program code encoded in tangible, computer-readable media. Tangible, computer-readable media refer to any media that is capable of providing data that causes the computing device 500 (i.e., a machine) to operate in a particular fashion. Various computer-readable media may be utilized to provide instructions to the processing unit 506 for execution. Example of tangible, computer-readable media may include but are not limited to, volatile media, non-volatile media, removable media, and non-removable media implemented in any method or technology for storage of information such as computer-readable instructions, data structures, program modules, or other data. System memory 504, removable storage 508, and non-removable storage 510 are all examples of tangible computer storage media. Examples of tangible, computer-readable recording media include but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 506 may execute program code stored in the system memory 504. For example, the bus may carry data to the system memory 504, from which the processing unit 506 receives and executes instructions. The data received by the system memory 504 may optionally be stored on the removable storage 508 or the non-removable storage 510 before or after execution by the processing unit 506.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, for example, through the use of an application programming interface (API), reusable controls, or the like. Such programs may be implemented in a high-level procedural or object-oriented programming language to communicate with a computer system. However, the program(s) can be implemented in assembly or machine language if desired. In any case, the language may be a compiled or interpreted language, and it may be combined with hardware implementations.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing systems (e.g., a combination of a DSP and a microprocessor, a plurality of microprocessors, one or more microprocessors in conjunction with a DSP core, or any other such configuration). Alternatively, some operations or methods may be performed by circuitry that is specific to a given function.

In one or more example embodiments, the functions described may be implemented in hardware, software, firmware, or any combination thereof. If implemented in software, the functions may be stored as one or more instructions or codes on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc, where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure

### CONCLUSION

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] Ayse Elvan Aydemir, Alptekin Temizel, and Tugba Taskaya Temizel. The effects of jpeg and jpeg2000 compression on attacks using adversarial examples. arXiv preprint arXiv:1803.10418, 2018.
[2] Tao Bai, Jinqi Luo, Jun Zhao, Bihan Wen, and Qian Wang. Recent advances in adversarial training for adversarial robustness. arXiv preprint arXiv:2102.01356, 2021.
[3] Pin-Yu Chen, Huan Zhang, Yash Sharma, Jinfeng Yi, and Cho-Jui Hsieh. Zoo: Zeroth order optimization based black-box attacks to deep neural networks without training substitute models. In Proceedings of the 10th ACM workshop on artificial intelligence and security, pp. 15-26, 2017.
[4] Francesco Croce and Matthias Hein. Reliable evaluation of adversarial robustness with an ensemble of diverse parameter-free attacks. In International conference on machine learning, pp. 2206-2216. PMLR, 2020a.
[5] Francesco Croce and Matthias Hein. Reliable evaluation of adversarial robustness with an ensemble of diverse parameter-free attacks. In International conference on machine learning, pp. 2206-2216. PMLR, 2020b.
[6] Adelina-Valentina Cucu, Giuseppe Valenzise, Daniela Stinescu, Ioana Ghergulescu, Lucian Ionel Gǎinǎ, and Bianca Guçiţǎ. Defense method against adversarial attacks using jpeg compression and one-pixel attack for improved dataset security. In 2023 27th International Conference on System Theory, Control and Computing (ICSTCC), pp. 523-527. IEEE, 2023.
[7] Nilaksh Das, Madhuri Shanbhogue, Shang-Tse Chen, Fred Hohman, Siwei Li, Li Chen, Michael E Kounavis, and Duen Horng Chau. Shield: Fast, practical defense and vaccination for deep learning using jpeg compression. In Proceedings of the 24th ACM SIGKDD International Conference on Knowledge Discovery & Data Mining, pp. 196-204, 2018.
[8] Alexey Dosovitskiy. An image is worth 16×16 words: Transformers for image recognition at scale. arXiv preprint arXiv:2010.11929, 2020.
[9] Haoqi Fan, Bo Xiong, Karttikeya Mangalam, Yanghao Li, Zhicheng Yan, Jitendra Malik, and Christoph Feichtenhofer. Multiscale vision transformers. In Proceedings of the IEEE/CVF international conference on computer vision, pp. 6824-6835, 2021.
[10] Zhengwei Fang, Rui Wang, Tao Huang, and Liping Jing. Strong transferable adversarial attacks via ensembled asymptotically normal distribution learning. In Proceedings of the IEEE/CVF Conference on Computer Vision and Pattern Recognition, pp. 24841-24850, 2024.
[11] Christoph Feichtenhofer. X3d: Expanding architectures for efficient video recognition. In Proceedings of the IEEE/CVF conference on computer vision and pattern recognition, pp. 203-213, 2020.
[12] Lianli Gao, Qilong Zhang, Jingkuan Song, Xianglong Liu, and Heng Tao Shen. Patch-wise attack for fooling deep neural network. In Computer Vision-ECCV 2020: 16th European Conference, Glasgow, UK, Aug. 23-28, 2020, Proceedings, Part XXVIII 16, pp. 307-322. Springer, 2020.
[13] Ian J Goodfellow, Jonathon Shlens, and Christian Szegedy. Explaining and harnessing adversarial examples. arXiv preprint arXiv:1412.6572, 2014.
[14] Benjamin Graham, Alaaeldin El-Nouby, Hugo Touvron, Pierre Stock, Armand Joulin, Hervé Jégou, and Matthijs Douze. Levit: a vision transformer in convnet's clothing for faster inference. In Proceedings of the IEEE/CVF international conference on computer vision, pp. 12259-12269, 2021.
[15] Kathrin Grosse, Praveen Manoharan, Nicolas Papernot, Michael Backes, and Patrick McDaniel. On the (statistical) detection of adversarial examples. arXiv preprint arXiv:1702.06280, 2017.
[16] Kaiming He, Xiangyu Zhang, Shaoqing Ren, and Jian Sun. Deep residual learning for image recognition. arxiv e-prints. arXiv preprint arXiv:1512.03385, 10, 2015.
[17] Teng-Fang Hsiao, Bo-Lun Huang, Zi-Xiang Ni, Yan-Ting Lin, Hong-Han Shuai, Yung-Hui Li, and Wen-Huang Cheng. Natural light can also be dangerous: Traffic sign misinterpretation under adversarial natural light attacks. In Proceedings of the IEEE/CVF Winter Conference on Applications of Computer Vision, pp. 3915-3924, 2024.
[18] Jaehui Hwang, Huan Zhang, Jun-Ho Choi, Cho-Jui Hsieh, and Jong-Seok Lee. Temporal shuffling for defending deep action recognition models against adversarial attacks. Neural Networks, 2023.
[19] Andrew Ilyas, Logan Engstrom, Anish Athalye, and Jessy Lin. Black-box adversarial attacks with limited queries and information. In International Conference on Machine Learning, pp. 2137-2146. PMLR, 2018.
[20] Will Kay, Joao Carreira, Karen Simonyan, Brian Zhang, Chloe Hillier, Sudheendra Vijayanarasimhan, Fabio Viola, Tim Green, Trevor Back, Paul Natsev, et al. The kinetics human action video dataset. arXiv preprint arXiv:1705.06950, 2017.
[21] Alex Krizhevsky, Geoffrey Hinton, et al. Learning multiple layers of features from tiny images. 2009.
[22] Alexey Kurakin, Ian J Goodfellow, and Samy Bengio. Adversarial examples in the physical world. In Artificial intelligence safety and security, pp. 99-112. Chapman and Hall/CRC, 2018.
[23] Fangzhou Liao, Ming Liang, Yinpeng Dong, Tianyu Pang, Xiaolin Hu, and Jun Zhu. Defense against adversarial attacks using high-level representation guided denoiser. In Proceedings of the IEEE conference on computer vision and pattern recognition, pp. 1778-1787, 2018.
[24] Aleksander Madry, Aleksandar Makelov, Ludwig Schmidt, Dimitris Tsipras, and Adrian Vladu. Towards deep learning models resistant to adversarial attacks. arXiv preprint arXiv:1706.06083, 2017.
[25] Jan Hendrik Metzen, Tim Genewein, Volker Fischer, and Bastian Bischoff. On detecting adversarial perturbations. arXiv preprint arXiv:1702.04267, 2017.
[26] Furkan Mumcu and Yasin Yilmaz. Sequential architecture-agnostic black-box attack design and analysis. Pattern Recognition, 147:110066, 2024a.
[27] Furkan Mumcu and Yasin Yilmaz. Fast and lightweight vision-language model for adversarial traffic sign detection. Electronics, 13(11):2172, 2024b.
[28] Furkan Mumcu and Yasin Yilmaz. Multimodal attack detection for action recognition models. In Proceedings of the IEEE/CVF Conference on Computer Vision and Pattern Recognition, pp. 2967-2976, 2024c.
[29] Furkan Mumcu, Keval Doshi, and Yasin Yilmaz. Adversarial machine learning attacks against video anomaly detection systems. In Proceedings of the IEEE/CVF Conference on Computer Vision and Pattern Recognition, pp. 206-213, 2022.
[30] Aamir Mustafa, Salman H Khan, Munawar Hayat, Jianbing Shen, and Ling Shao. Image super-resolution as a defense against adversarial attacks. IEEE Transactions on Image Processing, 29:1711-1724, 2019.
[31] Vassil Panayotov, Guoguo Chen, Daniel Povey, and Sanjeev Khudanpur. Librispeech: an asr corpus based on public domain audio books. In 2015 IEEE international conference on acoustics, speech and signal processing (ICASSP), pp. 5206-5210. IEEE, 2015.
[32] Tianyu Pang, Kun Xu, Chao Du, Ning Chen, and Jun Zhu. Towards robust detection of adversarial examples. In NeurIPS, 2018.
[33] Nicolas Papernot and Patrick McDaniel. Deep k-nearest neighbors: Towards confident, interpretable and robust deep learning. arXiv preprint arXiv:1803.04765, 2018.
[34] Nicolas Papernot, Patrick McDaniel, Ian Goodfellow, Somesh Jha, Z Berkay Celik, and Ananthram Swami. Practical black-box attacks against machine learning. In Proceedings of the 2017 ACM on Asia conference on computer and communications security, pp. 506-519, 2017.
[35] Adam Paszke, Sam Gross, Soumith Chintala, Gregory Chanan, Edward Yang, Zachary DeVito, Zeming Lin, Alban Desmaison, Luca Antiga, and Adam Lerer. Automatic differentiation in pytorch. 2017.
[36] Roi Pony, Itay Naeh, and Shie Mannor. Over-the-air adversarial flickering attacks against video recognition networks. In Proceedings of the IEEE/CVF Conference on Computer Vision and Pattern Recognition, pp. 515-524, 2021.
[37] Aaditya Prakash, Nick Moran, Solomon Garber, Antonella DiLillo, and James Storer. Deflecting adversarial attacks with pixel deflection. In Proceedings of the IEEE conference on computer vision and pattern recognition, pp. 8571-8580, 2018.
[38] Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. Learning transferable visual models from natural language supervision. In International conference on machine learning, pp. 8748-8763. PMLR, 2021.
[39] Olga Russakovsky, Jia Deng, Hao Su, Jonathan Krause, Sanjeev Satheesh, Sean Ma, Zhiheng Huang, Andrej Karpathy, Aditya Khosla, Michael Bernstein, Alexander C. Berg, and Li Fei-Fei. ImageNet Large Scale Visual Recognition Challenge. International Journal of Computer Vision (IJCV), 115(3):211-252, 2015. doi: 10.1007/s11263-015-0816-y.
[40] Hadi Salman, Mingjie Sun, Greg Yang, Ashish Kapoor, and J Zico Kolter. Denoised smoothing: A provable defense for pretrained classifiers. Advances in Neural Information Processing Systems, 33:21945-21957, 2020.
[41] Steffen Schneider, Alexei Baevski, Ronan Collobert, and Michael Auli. wav2vec: Unsupervised pre-training for speech recognition. arXiv preprint arXiv:1904.05862, 2019.
[42] Karen Simonyan and Andrew Zisserman. Very deep convolutional networks for large-scale image recognition. arXiv preprint arXiv:1409.1556, 2014.
[43] J. Stallkamp, M. Schlipsing, J. Salmen, and C. Igel. Man vs. computer: Benchmarking machine learning algorithms for traffic sign recognition. Neural Networks, (0):-, 2012. ISSN 0893-6080. doi: 10.1016/j.neunet. 2012.02.016. URL http://www.sciencedirect.com/science/article/pii/S893608012000457.
[44] Christian Szegedy, Wei Liu, Yangqing Jia, Pierre Sermanet, Scott Reed, Dragomir Anguelov, Dumitru Erhan, Vincent Vanhoucke, and Andrew Rabinovich. Going deeper with convolutions. In Proceedings of the IEEE conference on computer vision and pattern recognition, pp. 1-9, 2015.
[45] Yu Tian, Xiaopeng Yang, and Yuanqing Cai. Detecting adversarial examples through image transformations. In AAAI, 2018.
[46] Hugo Touvron, Matthieu Cord, Matthijs Douze, Francisco Massa, Alexandre Sablayrolles, and Herve Jegou. Training data-efficient image transformers & distillation through attention. In International conference on machine learning, pp. 10347-10357. PMLR, 2021.
[47] Du Tran, Heng Wang, Lorenzo Torresani, and Matt Feiszli. Video classification with channel-separated convolutional networks. In Proceedings of the IEEE/CVF international conference on computer vision, pp. 5552-5561, 2019.
[48] Xiaosen Wang and Kun He. Enhancing the transferability of adversarial attacks through variance tuning. In Proceedings of the IEEE/CVF conference on computer vision and pattern recognition, pp. 1924-1933, 2021.
[49] Ross Wightman. Pytorch image models. https://github.com/rwightman/pytorch-image-models, 2019.
[50] Chaowei Xiao, Ruizhi Deng, Bo Li, Taesung Lee, Benjamin Edwards, Jinfeng Yi, Dawn Song, Mingyan Liu, and Ian Molloy. Advit: Adversarial frames identifier based on temporal consistency in videos. In Proceedings of the IEEE/CVF International Conference on Computer Vision, pp. 3968-3977, 2019.
[51] Cihang Xie, Jianyu Wang, Zhishuai Zhang, Zhou Ren, and Alan Yuille. Mitigating adversarial effects through randomization. arXiv preprint arXiv:1711.01991, 2017.
[52] Zikang Xiong, Joe Eappen, He Zhu, and Suresh Jagannathan. Defending observation attacks in deep reinforcement learning via detection and denoising. In Joint European Conference on Machine Learning and Knowledge Discovery in Databases, pp. 235-250. Springer, 2022.
[53] W Xu. Feature squeezing: Detecting adversarial exa mples in deep neural networks. arXiv preprint arXiv:1704.01155, 2017a.
[54] W Xu. Feature squeezing: Detecting adversarial exa mples in deep neural networks. arXiv preprint arXiv:1704.01155, 2017b.
[55] Yijun Yang, Ruiyuan Gao, Yu Li, Qiuxia Lai, and Qiang Xu. What you see is not what the network infers: Detecting adversarial examples based on semantic contradiction. arXiv preprint arXiv:2201.09650, 2022.
[56] Bin Ye, Huilin Yin, Jun Yan, and Wanchen Ge. Patch-based attack on traffic sign recognition. In 2021 IEEE International Intelligent Transportation Systems Conference (ITSC), pp. 164-171. IEEE, 2021.
[57] Piotr Zelasko, Sonal Joshi, Yiwen Shao, Jesus Villalba, Jan Trmal, Najim Dehak, and Sanjeev Khudanpur. Adversarial attacks and defenses for speech recognition systems. arXiv preprint arXiv:2103.17122, 2021.
[58] Shuhai Zhang, Feng Liu, Jiahao Yang, Yifan Yang, Changsheng Li, Bo Han, and Mingkui Tan. Detecting adversarial data by probing multiple perturbations using expected perturbation score. In International conference on machine learning, pp. 41429-41451. PMLR, 2023.
[59] Yue Zhao, Hong Zhu, Ruigang Liang, Qintao Shen, Shengzhi Zhang, and Kai Chen. Seeing isn't believing: Towards more robust adversarial attack against real world object detectors. In Proceedings of the 2019 ACM SIGSAC conference on computer and communications security, pp. 1989-2004, 2019.

What is claimed:

1. A system for detecting adversarial inputs to a machine learning model, the system comprising:
at least one processor; and
a memory having instructions thereon, wherein the instructions when executed by the at least one processor, cause the at least one processor to:
receive, by an adversarial detection machine learning component, input data;
observe, by applying layer regression operations, internal changes to a subset of layers of the adversarial detection machine learning component caused by the input data; and
determining whether the input data is adversarial or clean based on the observed internal changes.

2. The system of claim 1, wherein applying the layer regression operations comprises:
generating an output vector for each of a plurality of segments in a subset of layers of the adversarial detection machine learning component;
generating a feature vector from the generated output vectors;
predicting behavior of the machine learning model using the generated feature vector; and
comparing actual behavior of the machine learning model with the predicted behavior.

3. The system of claim 2, wherein generating the output vector for each of a plurality of segments in the subset of layers comprises:
applying a slicing function to the subset of layers to generate each output vector.

4. The system of claim 2, wherein predicting behavior of the machine learning model using the generated feature vector comprises:
comparing a determined loss associated with the feature vector to a predetermined threshold, wherein the threshold is determined by calculating a corresponding loss for a set of clean inputs.

5. The system of claim 1, wherein the subset of layers are selected from intermediate and/or succeeding layers of a plurality of layers of the adversarial detection machine learning component.

6. The system of claim 1, wherein the adversarial detection machine learning component is a trained multilayer perceptron (MLP).

7. The system of claim 6, wherein the adversarial detection machine learning component is trained by optimizing weights (w) to minimize mean squared error (MSE) loss.

8. The system of claim 1, wherein the memory comprises instructions which when executed by the at least one processor cause the at least one processor to further:
generate an alert and/or take a corrective action in response to determining that the input data is adversarial.

9. The system of claim 1, wherein the machine learning model is employed in an image recognition, video analysis, or audio recognition system.

10. The system of claim 1, wherein the adversarial detection machine learning component is an add-on module to the machine learning model.

11. The system of claim 10, wherein the machine learning model is a deep neural network model.

12. A computer-implemented method comprising:
receiving, by at least one processor and via an adversarial detection machine learning component, input data, wherein the adversarial detection machine learning component is a component of a machine learning model;
observing, by the at least one processor and by applying layer regression operations, internal changes to a subset of layers of the adversarial detection machine learning component caused by the input data; and
determining, by the at least one processor, whether the input data is adversarial or clean based on the observed internal change.

13. The computer-implemented method of claim 12, wherein applying the layer regression operations comprises:
generating, by the at least one processor, an output vector for each of a plurality of segments in a subset of layers of the adversarial detection machine learning component;
generating, by the at least one processor, a feature vector from the generated output vectors;
predicting, by the at least one processor, behavior of the machine learning model using the generated feature vector; and
comparing actual behavior of the machine learning model with the predicted behavior.

14. The computer-implemented method of claim 13, wherein generating the output vector for each of a plurality of segments in the subset of layers comprises:
applying by the at least one processor, a slicing function to the subset of layers to generate each output vector.

15. The computer-implemented method of claim 13, wherein predicting behavior of the machine learning model using the generated feature vector comprises:
comparing a determined loss associated with the feature vector to a predetermined threshold, wherein the threshold is determined by calculating a corresponding loss for a set of clean inputs.

16. The computer-implemented method of claim 13, wherein the adversarial detection machine learning component is a trained multilayer perceptron (MLP).

17. The computer-implemented method of claim 13, wherein the adversarial detection machine learning component is trained by optimizing weights (w) to minimize mean squared error (MSE) loss.

18. The computer-implemented method of claim 12, further comprising:
generating an alert and/or taking a corrective action in response to determining that the input data is adversarial.

19. The computer-implemented method of claim 12, wherein the machine learning model is a DNN employed in an image recognition, video analysis, or audio recognition system.

20. A computer program product comprising at least one non-transitory computer-readable storage medium having computer-readable program code portions stored therein, the computer-readable program code portions comprising program code instructions, the computer program code instructions, when executed by a processor, are configured to cause the processor to:
receive, by an adversarial detection machine learning component, input data;
observe, by applying layer regression operations, internal changes to a subset of layers of the adversarial detection machine learning component caused by the input data; and
determining whether the input data is adversarial or clean based on the observed internal changes.
